(19) United States
(12) Patent Application Publication
(10) Pub. No.: US 2023/0135433 A1
(43) Pub. Date: May 4, 2023

(54) Method of Anaerobically Treating Wastewater Including a Buffer Pre-Acidification Tank Operated as a Moving Bed Bioreactor

(71) Applicants: Santiago PACHECO-RUIZ, Maassluis (NL); Fernando GAN-SAGASTUME, Malmö (SE); Jeronimus Gerardus Maria VAN DER LUBBE, Rijswijk (SE); Thomas WELANDER, Furulund (SE); Ana Lucia FERREIRA, Leiden (NL); Veolia Water Solutions & Technologies Support, Saint-Maurice (FR)

(72) Inventors: Santiago Pacheco-Ruiz, Maassluis (NL); Fernando Morgan-Sagastume, Malmö (SE); Jeronimus Gerardus Maria van der Lubbe, Rijswijk (NL); Thomas Welander, Furulund (SE); Ana Lucia Ferreira, Leiden (NL)

(21) Appl. No.: 17/915,555

(22) PCT Filed: Mar. 30, 2021
(86) PCT No.: PCT/IB2021/052637

§ 371 Date: Sep. 29, 2022

Related U.S. Application Data
(60) Provisional application No. 63/003,372, filed on Apr. 1, 2020.

(51) Int. Cl. C02F 3/28

(52) U.S. Cl. CPC C02F 3/2833; C02F 2209/06

(57) ABSTRACT

The present invention relates to a system or process for anaerobically treating wastewater. The system employs a pre-treatment unit that includes an MBBR having biomass supported on biofilm carriers. The biomass hydrolyzes or leads to a level of hydrolysis of particulate matter and acidifies the wastewater. In the process, the biomass yields relatively high acid production rates while employing a relatively short hydraulic retention time.

### FIELD OF THE INVENTION

The present invention relates to systems and processes for anaerobically treating wastewater or sludge.

### BACKGROUND OF THE INVENTION

Equalization tanks are typically used in wastewater treatment systems. Equalization is understood as the dampening of the effects of increases or decreases in volumetric loading rate and/or a decrease or increase in hydraulic retention time (HRT). Completely stirred tank reactors (CSTRs) are conventionally used as storage or equalization tanks. Conventional anaerobic treatment systems also may include equalization tanks. In some cases, these equalization tanks may give rise to some incidental and uncontrolled pre-acidification upstream of an anaerobic reactor. However, there are many drawbacks and disadvantages to employing an equalization tank with uncontrolled pre-acidification.

HRTs below 18-24 h cannot be used impacting high CAPEX for equalization tanks (about 10-15% of CAPEX of any anaerobic technology)
The levels of pre-acidification cannot be controlled since the variations in volume and HRT impact the performance of biomass in the tank and negatively affect the stability of the pre-acidification. These variations impact negatively on the following anaerobic treatment.
HRT is coupled to active biomass retention time (cell or sludge retention time or SRT) and risks for biomass washout exists, which impact pre-acidification.
Changes in HRT directly cause changes in SRT, which is known to affect the selection of acidogenic biomass and pre-acidification performance

With conventional equalization tanks, the pH and HRT might not be controlled. They both, however, can impact an equalization tank being used for pre-acidification. HRT has significant impact on the hydrolysis and eventual transformation of particulate substrate (e.g., proteins, fats) and microbial metabolism, and influences microbial community composition. With respect to these same compounds, an acidic pH can change the state of these compounds from soluble compounds to colloidal/particulate. A relatively high HRT will result in high CAPEX of a pre-acidification tank. Thus, when it comes to equalization tanks that might be used for pre-acidification in anaerobic treatment processes, it is clear that there is a need to increase or maintain the acidification rate and its robustness, and at the same time, there is a need to reduce the HRT in order to decrease costs.

### SUMMARY OF THE INVENTION

The present invention relates to a system or process for anaerobically treating wastewater. The term “wastewater” as used herein includes all forms of wastewater, such as industrial or municipal wastewater, sludge, effluents or combinations thereof, etc. The system of the present invention employs pre-treatment that includes a moving bed biofilm reactor (MBBR) having biomass supported on biofilm carriers. The biomass hydrolyzes or leads to a level of hydrolysis of particulate matter and acidifies the wastewater. In the process, as described below, the biomass yields relatively high acid production rates with associated acidification levels while employing a relatively short hydraulic retention time (HRT).

There are several distinguishing features of the present invention. Firstly, the acid production rates achieved with biofilm carriers at relatively short HRT are higher compared to acidification processes that simply rely on suspended biomass and that require longer HRT. In addition, the level of acidification achieved with biofilm carriers and a relatively short HRT is similar to that of acidification processes that simply rely on suspended biomass. Secondly, the biofilm on the carriers provides improved process robustness in terms of acid production rates and acidification level when the buffer tank is exposed to variations in load, whether hydraulic or organic loads. Biofilm on the carriers also provides for a faster recovery under variable load conditions compared to conventional acidification processes, such as those carried out in CSTR. Thirdly, the MBBR buffer tank can still equalize hydraulic and organic loads at a relatively smaller volume tank compared to, for example, conventional CSTR equalization tanks. Fourth, in some cases when employing relatively small pre-acidification buffer tanks, if there is a need to increase or decrease acidification levels, then this can be achieved by modifying the amount of biofilm carriers in the tank.

In one embodiment, the present invention includes a process of treating wastewater in a wastewater treatment system designed to reduce capital expenditures (CAPEX) of the system. This process in this embodiment comprises:
directing the wastewater into a pre-acidification moving bed bioreactor (MBBR) buffer tank;
placing biofilm carriers in the MBBR buffer tank and accumulating biomass on the biofilm carriers, and wherein the biofilm carriers include protected surface areas;
maintaining the MBBR buffer tank under anaerobic conditions;
maintaining the hydraulic retention time (HRT) in the MBBR buffer tank to less than 12 hours;
maintaining the hydraulic surface load per carrier protected surface area in the MBBR buffer tank within the range of 5 to 70 L/m²d while maintaining the HRT in the MBBR buffer tank at less than 12 hours;
while maintaining the HRT in the MBBR buffer tank at less than 12 hours and while maintaining the hydraulic surface load per carrier protected surface area in the buffer tank within the range of 5-70 L/m²d, hydrolyzing and pre-acidifying the wastewater in the MBBR buffer tank;
monitoring the pH of the wastewater in the MBBR buffer tank and controlling the pH therein in the range of 4 to 7; and
after the wastewater has been hydrolyzed and pre-acidified, directing the wastewater from the MBBR buffer tank to a downstream biological aerobic or anaerobic reactor for aerobically or anaerobically treating the wastewater.

In other embodiments, the process of the present invention comprises: wherein for a given range of wastewater influent flows into the MBBR buffer tank, the process maintains the hydraulic surface load per carrier protected surface area in the MBBR buffer tank within the range of 5 to 70 L/m²d and by sizing the MBBR buffer tank and controlling the quantity of biofilm carriers placed in the MBBR buffer tank. Expressed differently, in one embodiment of the process, there is a range of hydraulic surface loading which is established or set by the range of wastewater influent flow into the MBBR buffer tank, the volume of the MBBR buffer tank, and the protected surface area of the biofilm carriers in the MBBR buffer tank.

Other objects and advantages of the present invention will become apparent and obvious from a study of the following description and the accompanying drawings which are merely illustrative of such invention.

### BRIEF DESCRIPTION OF THE DRAWINGS

FIG. 1 is a graph showing organic acid production rates in an anaerobic MBBR buffer tank for various hydraulic surface loads, and a comparison of the maximum expected organic acid production rate for a CSTR operated at an HTR of 18 hours.

FIG. 2 is a graph that depicts organic acid production rates for: (1) a CSTR operated at an HRT of 18 hours and (2) an anaerobic MBBR operated at an HRT of 6 hours.

### DESCRIPTION OF EXEMPLARY EMBODIMENTS

Treatment processes for industrial wastewater generally include an equalization tank (sometimes referred to as a buffer tank) that buffers variations in the incoming wastewater characteristics. Conventional equalization or buffering tanks include storage volumes with long retention times. CSTRs operated as equalization tanks typically have an HRT of 18-24 hours. In the anaerobic treatment of wastewater, equalization tanks are also used to buffer variations in hydraulic and organic loads, pH and toxic contents. In these equalization tanks, some level of uncontrolled pre-acidification may occur. High or variable levels of pre-acidification, defined as the ratio of COD concentration provided by fermentation products (organic acids, such as volatile fatty acids (VFAs), and alcohols) to the total concentration of soluble COD (SCOD), are generally observed in equalization tanks, depending on whether the biodegradability of the wastewater is high or low. The positive impact that good substrate pre-acidification has on the performance of anaerobic treatment processes is recognized. However, conventional pre-acidification processes are inefficient and costly because they require relatively large HRTs, typically 18-24 hours, and this in turn requires relatively large pre-acidification tanks. This impacts capital costs (CAPEX). There are opportunities to substantially improve anaerobic processes and particularly pre-acidification systems and processes by:

particularly designing the buffer tank (typically about 10-15% of CAPEX of any anaerobic technology) to yield a relatively short HRT range based on expected influent flows
reducing caustic consumption to control the pH (main OPEX item of any anaerobic technology)
improving overall reactor design as higher volumetric loading rates could be considered (lower CAPEX)
overall system robustness and stability (lower overall OPEX)

Suspended biomass is one of the most commonly used technologies to produce VFAs. It is known to use CSTRs in anaerobic fermentation processes because they are simple in design and facilitate the monitoring of process parameters. By employing a CSTR, a good mixture of influent and microorganisms is achieved in the presence of suspended biomass and suspended solids.

Acidogens require a minimum HRT for hydrolysis and acidogenesis. Regular hydraulic retention time of a system depends on the type and composition of the substrate. In the present invention, pH, HRT and hydraulic surface loading of the MBBR are the main parameters controlled in a pre-acidification process. Many conventional anaerobic processes require HRTs that exceed one day. For example, an anaerobic leaching bed reactor that digests high solid content substrates typically employs HRTs of 1.5 days. In an acid producing anaerobic digestion process, one can expect a typical HRT of approximately 1.9 days.

Moving bed biofilm reactors (MBBRs) are a mature technology used in the biological treatment of wastewaters. In an MBBR, microbial biomass is employed to remove pollutants from the wastewater. This biomass grows as a biofilm upon free-moving carrier media sometimes referred to as biofilm carriers. The carriers are retained in the reactor volume by means of sieves located at the outlet point. In anoxic or anaerobic MBBRs, the carriers are mechanically mixed and thereby kept in suspension in the reactor. An MBBR operated anaerobically (Anoxthane™ anaerobic MBBR as commercialized by AnoxKaldnes/BIOTHANE-Veolia Water Technologies) can be used for the treatment of liquid waste streams and the production of biogas following full anaerobic digestion. An anaerobic MBBR (AnMBBR) can also be used for achieving acidification of the easily hydrolysable and degradable organic content of wastewaters.

This invention relates to an anaerobic wastewater treatment system and process. The process includes pre-treatment followed by some form of anaerobic treatment, such as an anaerobic digester. Here pre-treatment includes the employment of a buffer or equalization tank that includes biofilm carriers supporting biomass and that is operated under anaerobic conditions. The buffer tank is designed to perform a pre-acidification process which essentially entails employing anaerobic microorganisms (anaerobes) to break down complex organic compounds into simpler alcohols and organic acids, such as VFAs. In particular, the pre-acidification process is designed to convert soluble chemical oxygen demand (SCOD) to VFAs. The aim of the process is to achieve a high acidification level (VFA-COD/SCOD) with a relatively short HRT. A relatively short HRT is defined to mean an HRT of less than 18 hours. As discussed below in some cases, the HRT can be less than 12 hours and in other cases it can be 6 hours or less. that is substantially or significantly shorter than conventional acidification HRTs of 18-24 hours.

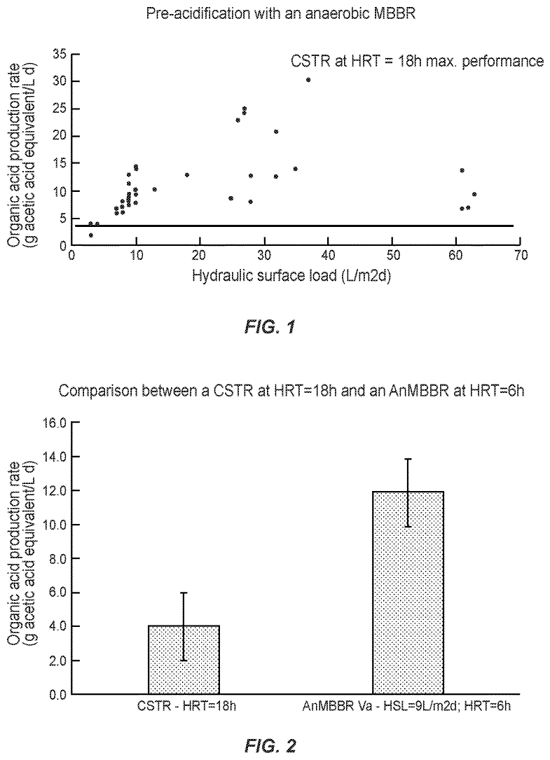

Underlying the present invention is some experimental work that examines organic acid production rates for AnMBBR processes operated at a relatively low HRT and CSTRs operated at higher HRTs, for example 18 hours and above. The underlying work also investigated organic acid production rates over a range of hydraulic loading rates for the AnMBBR. See FIGS. 1 and 2.

FIG. 1 shows organic production rates for a range of hydraulic surface loads (HSL) for an AnMBBR buffer tank. The term “hydraulic surface loading” is a measure of the hydraulic load per protected surface area of the biofilm carriers in the buffer tank, expressed as liters per m²-day (L/m²d). Note that the organic acid production rate for the AnMBBR varied over the range of HSL. Starting at about an HSL of 7 L/m²d, the AnMBBR produced significant organic acid production rates. At an HSL of 60 L/m²d, the AnMBBR still produced a significant rate of organic acid production. It is hypothesized that the organic acid production rate at 70 L/m²d would be similar to the HSL of 60 L/m²d or at least significant. These organic acid production rates are contrasted in FIG. 1 with the maximum performance contemplated for a CSTR operated at an HRT of 18 hours. This is represented by the horizontal line extending across the graph of FIG. 1. The differences in the organic acid production rates are quite substantial.

FIG. 2 is also enlightening. This shows the organic acid production rate for a CSTR operated at an HTR of 18 hours and an AnMBBR where the HRT is controlled at 6 hours and the HSL is maintained at 9 L/m²d.

From the underlying tests and data, the inventors determined that a process for hydrolyzing and pre-acidifying wastewater or sludge in a buffer tank could be substantially improved by employing an AnMBBR at a controlled HRT and by maintaining the HSL within a range of 7-70 L/m²d. Not only is the overall hydrolyzing and pre-acidification process improved, but in many cases the overall capital cost is reduced.

Compared to convention pre-acidification processes, the present invention utilizes fixed film biomass as opposed to suspended biomass in the pre-acidification buffer tank. Secondly, the present invention calls for controlling or maintaining HRT at less than 18 hours and preferably less than 12 hours. Closely related to HRT is the HSL associated with the protected surface area of the biofilm carriers. One of the inventive concepts of the present invention is to limit HRT (less than 18 hours) compared to conventional approaches and at the same time control or maintain HSL within the range of 7-70 L/m²d. HRT and HSL are designed around the expected influent flow or a range of influent flows into the buffer tank. Based on expected influent flows, the volume of the buffer tank is designed to yield a range of HRTs less than 18 hours, and preferably less than 12 hours. For a given influent flow, the HSL can be managed or controlled by filling the buffer tank with a certain quantity of biofilm carriers, paying particular attention to their protected surface area. In the end, the desire is for the process to have a relatively short HRT and at the same time experience an HSL in the range of 7-70 L/m²d. Practically, it is appreciated that HRT of the buffer tank will vary. When HRT varies, it follows that HSL will vary accordingly. But over substantial periods of time, the variations will not be great and will not result in the HRT exceeding 18 hours or the HSL falling outside of the desired range. The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A process for treating wastewater in a wastewater treatment system designed to reduce capital expenditures (CAPEX) of the system, the process comprising:
directing the wastewater into a pre-acidification moving bed bioreactor (MBBR) buffer tank;
placing biofilm carriers in the MBBR buffer tank and accumulating biomass on the biofilm carriers, and wherein the biofilm carriers include protected surface areas;
maintaining the MBBR buffer tank under anaerobic conditions;
maintaining the hydraulic retention time (HRT) in the MBBR buffer tank to less than 12 hours;
maintaining the hydraulic surface load (HSL) per carrier protected surface area in the MBBR buffer tank within the range of 5 to 70 L/m²d while maintaining the HRT in the MBBR buffer tank at less than 12 hours;
while maintaining the HRT in the MBBR buffer tank at less than 12 hours and while maintaining the hydraulic surface load per carrier protected surface area in the buffer tank within the range of 5-70 L/m²d, hydrolyzing and pre-acidifying the wastewater in the MBBR buffer tank;
monitoring the pH of the wastewater in the MBBR buffer tank and controlling the pH therein in the range of 4 to 7; and
after the wastewater has been hydrolyzed and pre-acidified, directing the wastewater from the MBBR buffer tank to a downstream biological aerobic or anaerobic reactor for aerobically or anaerobically treating the wastewater.

2. The method of claim 1 wherein the pre-acidification process carried out in the MBBR buffer tank produces approximately 6 to approximately 12 grams of acidic acid or equivalent per liter day.

3. The process of claim 1 wherein for a given range of wastewater influent flows into the MBBR buffer tank, maintaining the hydraulic surface load per carrier protected surface area in the MBBR buffer tank within the range of 5 to 70 L/m²d includes sizing the MBBR buffer tank and controlling the quantity of biofilm carriers placed in the MBBR buffer tank.

4. The process of claim 1 wherein the range of hydraulic surface loading is set by the range of wastewater influent flow into the MBBR buffer tank, the volume of the MBBR buffer tank, and the protected surface area of the biofilm carriers in the MBBR buffer tank.

5. The process of claim 1 including employing an MBBR buffer tank having a certain volume which yields an HRT of less than 12 hours for a certain range of wastewater influent flows.
